(19) United States
(12) Patent Application Publication
(10) Pub. No.: US 2013/0134762 A1
(43) Pub. Date: May 30, 2013

(54) QUICK DISASSEMBLY STRUCTURE OF SEAT FOR SCOOTER

(71) Applicant: CHEN-CHI HSIAO, CHIA YI CITY (TW)

(72) Inventor: CHEN-CHI HSIAO, CHIA YI CITY (TW)

(73) Assignee: SUNPEX TECHNOLOGY CO., LTD., CHIA YI CITY (TW)

(21) Appl. No.: 13/304,448

(22) Filed: Nov. 25, 2011

(51) Int. Cl. B60N 2/44

(52) U.S. Cl. 297/440.1

(57) ABSTRACT

A quick disassembly structure of seat for a scooter has a seat which is provided with two support leg units and a seat section assembled with the two support leg units. A frame major body is provided with pivot mounts on which accommodation grooves are provided for receiving the ends of support leg units, and engaging slots are provided on the side walls of the accommodation grooves for engaging with tenons provided at the lateral sides of the support leg units' ends. Latch pieces are hinged on the upper edges of the pivot mounts so as to cover the engaging slots of the pivot mounts.

### BACKGROUND OF INVENTION

1. Field of the Invention

The present invention relates to a quick disassembly structure of seat for a scooter, more particularly to a quick disassembly structure of seat for a scooter by which the seat and the frame major body can be disassembled, and the scooter in storage condition can be arranged with good flexibility in barn according to the delivery and stock space so as to increase the convenience of accommodation in delivery and warehousing.

2. Brief Description of Prior Art

Referring to Taiwanese Patent No. M374858 entitled as “Frame and Seat Structure of Scooter”, main beams and sleeves fitting together are provided between the front frame and the rear frame, and the seat section is assembled with the rear frame by support leg units. Configuring like this, by the guiding of the sleeves and the main beam provided between the front and the rear frames, the front and the rear frames can be collapsed smoothly. Further, the support leg units allow the seat section to be lifted and lowered to collapse by the design of first links and second links intersecting and hinged together. In this manner, collapsible mechanisms are provided in the frames and the seat section of scooter so as to effectively minimize the total volume of scooter. Therefore, the storage and delivery of scooter become very convenient.

However, in the conventional Taiwanese Patent No. M374858 entitled as “Frame and Seat Structure of Scooter” also proposed by the inventor of this invention, the seat section and the frames are assembled together by the first links and the second links intersecting and hinged together, wherein a third link is used to connect between the two first links, while a fourth link is connected between the two second links; the upper end of the third link is pivotally connected with the rear edge at the bottom side of the seat section, while the bottom end of the third link is pivotally connected with an engaging slot provided at the front edge of the frame; further, the upper end of the fourth link is abutted with an abutting slot provided at the front edge at the bottom side of the seat section, while the bottom end of the fourth link is fixedly hinged at the rear edge of the frame. According to this structural design, the chair can be lifted and lowered to be folded. However, since the lower end of the fourth link is fixedly hinged at the rear edge of the frame, disassembly can be done only by a special tool; hence the chair cannot be separated from the frame in usage. Not only the collapsed configuration of the scooter is limited so that the scooter cannot effectively stocked according to delivery and storage space conditions, but also user cannot replace a damaged chair with a new one immediately and should send for repair. Under this circumstance, users have no scooter to use for a period of time and this may cause inconvenience in daily life especially for disabled person and aged people.

### SUMMARY OF INVENTION

The present invention relates to a quick disassembly structure of seat for a scooter, the main object is to provide a quick disassembly technology for scooter enabling the disassembly of the chair and the frame so that the scooter can be arranged in barn with good flexibility according to the delivery and stock space so as to increase the convenience of accommodation in delivery and warehousing.

In order to achieve the above objects, the present invention proposes a quick disassembly structure of seat for a scooter comprising a frame major body and a seat, wherein the seat is provided with two support leg units and a seat section assembled with the two support leg units; the frame major body is provided with pivot mounts on which accommodation grooves are provided for receiving the ends of support leg units, and engaging slots are provided on the side walls of the accommodation grooves for engaging with tenons provided at the ends of lateral sides of the support leg units; latch pieces are hinged on the upper edges of the pivot mounts so as to cover the engaging slots of the pivot mounts.

By the quick disassembly structure of seat for a scooter, the seat and the frame major body can be disassembled so that the scooter in storage condition can be arranged in barn with good flexibility according to the delivery and stock space so as to increase the convenience of accommodation in delivery and warehousing.

### BRIEF DESCRIPTION OF THE DRAWINGS

FIG. 1 is a perspective exploded view of the present invention.

FIG. 2 is a front view of the present invention.

FIG. 3 is another front view of the present invention.

FIG. 4 is a partial enlarged front view of the present invention.

FIG. 5 is a view showing the state of use of the present invention.

FIG. 6 is an overview of the present invention.

### DETAILED DESCRIPTION OF PREFERRED EMBODIMENTS

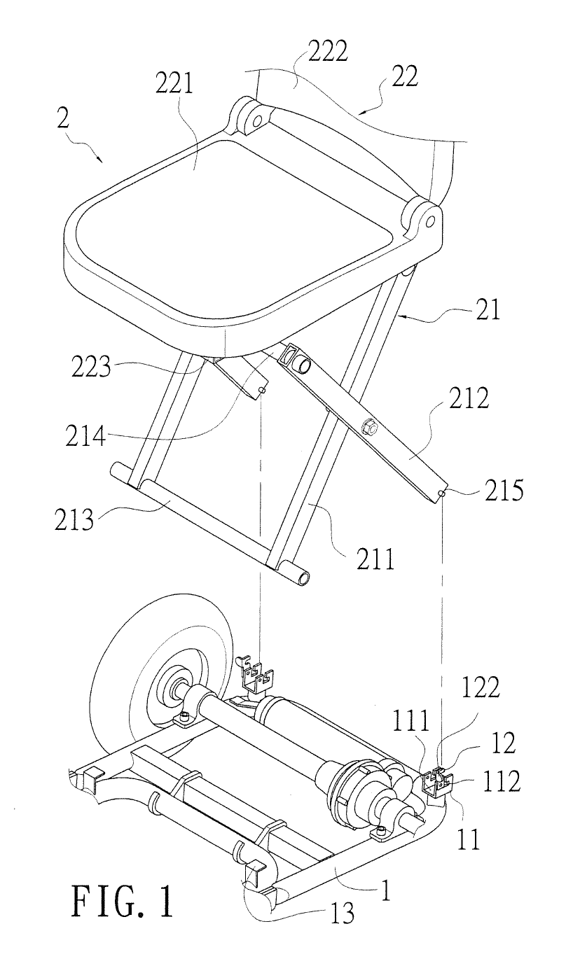

Firstly referring to FIG. 1, the quick disassembly structure of seat for a scooter of the present invention comprises a frame major body (1) and a seat (2) assembled on the frame major body (1).

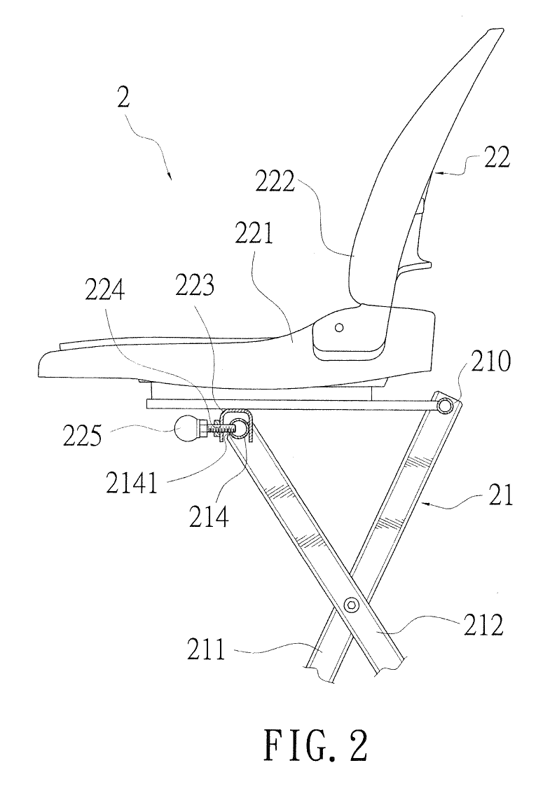

As shown in FIG. 2, the seat (2) includes a seat section (22) and two support leg units (21) provided at both sides of the seat section (22). The seat section (22) includes a chair (221) and a seat back (222) hinged on the chair (221). Each support leg unit (21) includes a first link (211) and a second link (212) intersecting with each other and hinged together at the intersection point; a pivot rod (210) perforates through the upper end of each first link (211) and the rear edge of the chair (221) of the seat section (22), while a fourth link (214) is welded between the upper ends of the two second links (212); the fourth link (214) is abutted and received within an abutting groove (223) provided at the bottom front edge of the chair (221) of the seat section (22); pin holes (2141), (224) corresponding to each other are respectively provided on the fourth link (214) and the abutting groove (223), and a pin (225) is inserted in the pin hole (224) of the abutting groove (223) so as to penetrate through pin holes (224), (2141) on the abutting groove (223) and the fourth link (214); a third link (213) is welded between the bottom ends of the two first link (211), the third link (213) being received in a fitting groove (13) provided on the frame major body (1) and is engaged therewith.

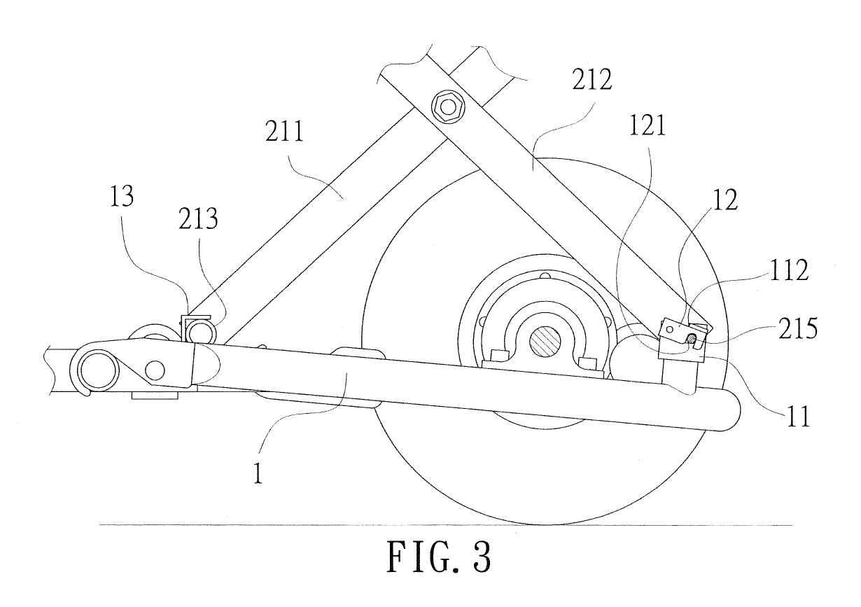

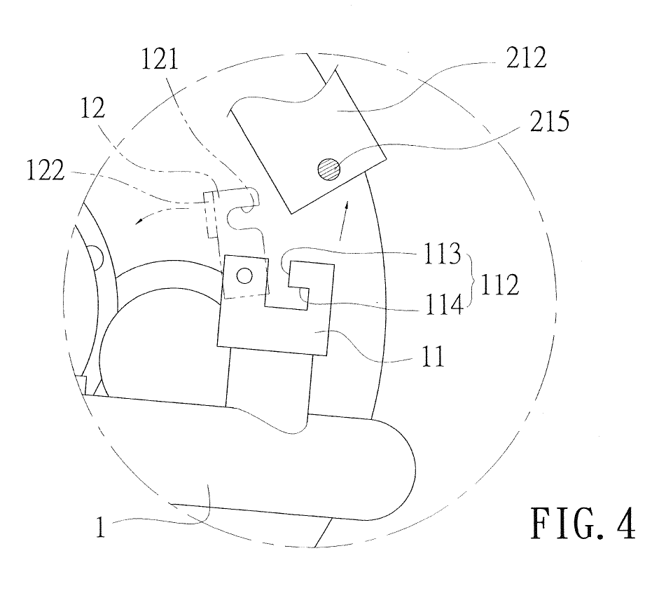

Next referring to FIGS. 3 and 4, a tenon (215) is provided at the lateral side of the bottom end of each second link (212); pivot mounts (11) are provided on the frame major body (1) to correspond to the second links (212). The pivot mounts (11) include accommodation grooves (111) for receiving the second links (212), and engaging slots (112) are provided at both side walls of the accommodation grooves (111). Each engaging slot (112) include a vertical cut-out portion (113) extending downward from the upper edge of the side wall of the accommodation groove (111) and a horizontal cut-out portion (114) connecting laterally with the vertical cut-out portion (113), so that the tenon (215) provided at the bottom end of each second link (212) enters into the vertical cut-out portion (113) and then engages in the horizontal cut-out portion (114). The end of each tenon (215) is extended to the outside of the engaging slot (112). Further, latch pieces (12) hinge at the upper edges of the pivot mounts (11) are used to cover the engaging slots (112) of the pivot mounts (11); hook portions (121) are formed on the bottom edges of the latch pieces (12) for engaging with the ends of the tenons (215) extending to the outsides of the engaging slots (112). Handles (122) are provided on the side edges of the latch pieces (12)

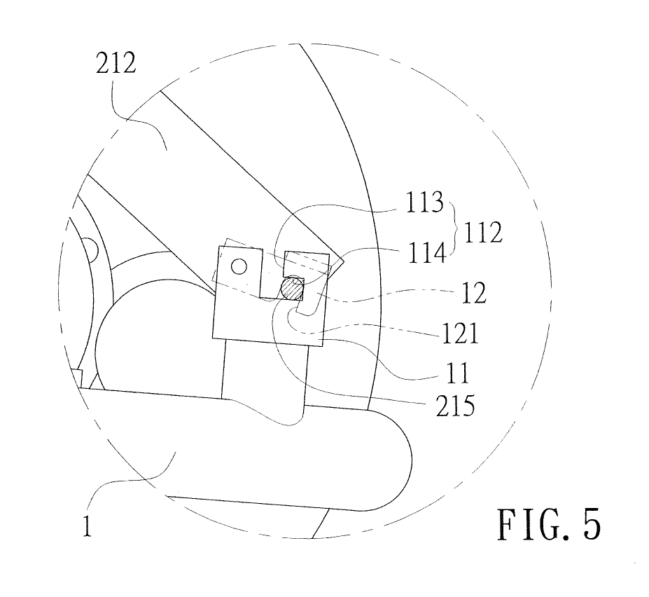

Configuring like this, when users want to drive the scooter, referring to FIGS. 1 and 5, the seat (2) is assembled on the frame major body (1) in such a manner that the first links (211) and the second links (212) of the seat section (22) are unfolded first. In turn, the bottom ends of the second links (212) are disposed in the accommodation grooves (111) of the pivot mounts (11) on the frame major body (1), and the tenons (215) at both sides of the second links (212) enter the vertical cut-out portions (113) of the engaging slots (112) and displace to the horizontal cut-out portions (114) and are fitted therewith. Then, the latch pieces (12) on the upper edges of the pivot mounts (11) are turned downward so that the hooks portions (121) on the bottom edges of the latch pieces (12) engage with the ends of the tenons (215) extending to the outsides of the engaging slots (112). In this manner, the assembly of the second links (212) of the seat (2) with the frame major body (1) is completed.

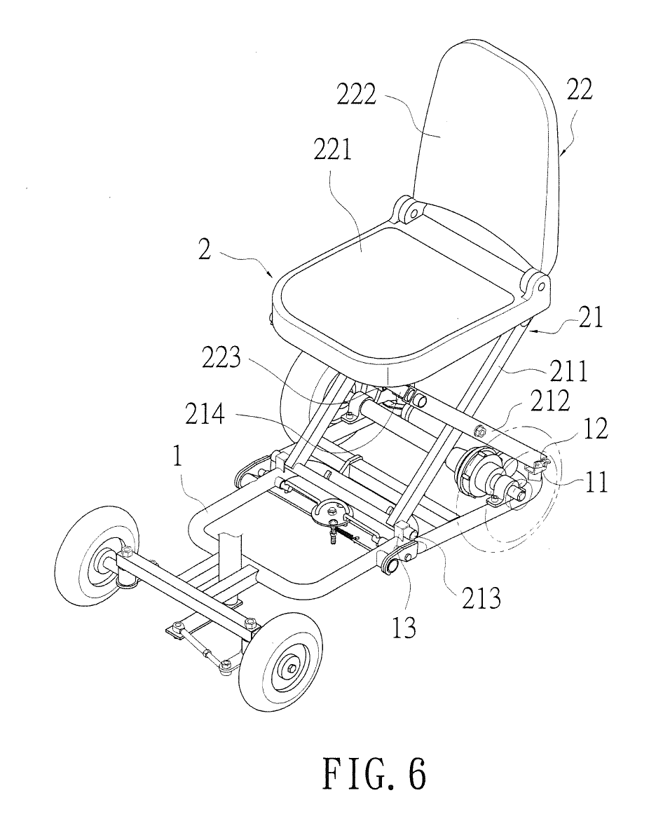

Next, referring to FIGS. 2 and 3, the third link (213) welded between the bottom ends of the first links (211) is engaged in the fitting grooves (13) provided at the frame major body (1) so as to lock the bottom ends of the first links (211) on the frame major body (1). In turn, the abutting groove (223) provided at the front edge of the chair (221) is moved with the pivot rod (21) perforating through the upper ends of the first links (211) and the chair (221) of the seat section (22) as the center, until the fourth link (214) is accommodated in the abutting groove (223). At this moment, the pin holes (224), (2141) of the abutting groove (223) and the fourth link (214) are in alignment, so the pin (225) is inserted through the pin holes (224), (2141) and thus the fourth link (214) is secured in the abutting groove (223) of the chair (221). In this manner, the seat section (22) can be securely supported by the support leg units (21), as shown in FIG. 6. Then, users can sit comfortably on the seat (2) to drive the scooter.

Next, when the scooter is to be collapsed for better delivery or storage, referring again to FIGS. 2 and 3, the pin (225) engaged in the pin holes (224), (2141) of the abutting groove (223) and the fourth link (214) is pulled out, then the seat section (22) can be lifted upward and the fourth link (214) received in the abutting groove (223) of the chair (221) is released from the abutting groove (223). Accompanying with the release of the fourth link (214), the locking of the support leg units (21) is released so that the third link (213) is pulled out from the fitting grooves (13) of the frame major body (1). Then, the first links (211) and the second links (212) intersecting with each other and hinged together are collapsed so that the seat back (222) of the seat section (22) can be laid down horizontally with the chair (221). In this manner, the seat (2) is collapsed to be flattened so that the volume of the scooter is significantly reduced.

When the scooter is further to be flattened in limited delivery and storage space condition, referring to FIGS. 4 and 5, the seat (2) and the frame major body (1) is further to be disassembled. Firstly, latch pieces (12) which lock the bottom ends of the second link (212) and the frame major body (1) together is turned upward so as to release the hooking engagement between the tenons (215) and the hooks portions (121) of the latch pieces (12). Then, the tenons (215) are moved out from the horizontal cut-out portions (114) and pulled out from the vertical cut-out portions (113) so as to be detached from the engagement with the pivot mounts (11) of the frame major body (1). In this manner, the seat (2) can be completely separated from the frame major body (1) to allow the scooter becoming more flattened. The seat (2) thus disassembled can be disposed vertically or stocked in any other way so that flexibility and convenience of stocking in the delivery and the storage of the scooter can be enhanced.

Furthermore, when the seat (2) is damaged, users can directly disassemble the damaged seat (2) from the frame major body (1) and then assemble a new seat (2) on the frame major body (1) by themselves without sending for repair. Therefore, inconvenience resulting from sending for repair such as no scooter to use for a period of time in daily life can be avoided.

What is claimed is:

1. A quick disassembly structure of seat for a scooter, comprising a frame major body and a seat, wherein said seat is provided with two support leg units and a seat section assembled with said two support leg units; said frame major body being provided with pivot mounts on which accommodation grooves are provided for receiving the ends of said support leg units, and engaging slots being provided on the side walls of the accommodation grooves for engaging with tenons provided at the ends of lateral sides of said support leg units; latch pieces being hinged on the upper edges of said pivot mounts so as to cover said engaging slots of said pivot mounts.

2. The quick disassembly structure of seat for a scooter as claimed in claim 1, wherein said support leg unit are disposed at both sides of said seat section and each said support leg unit includes a first link and a second link intersecting with each other and hinged together at the intersection point, the upper ends of said first links and said second links being in pivotal connection respectively to the rear edge and the front edge of said seat section, a third link being fixedly connected between said two first links, a fitting groove being provided on said frame major body for fitting with said third link, said pivot mounts being disposed oppositely to the fitting groove so as to be connected with the bottom ends of said second links.

3. The quick disassembly structure of seat for a scooter as claimed in claim 2, wherein a fourth link is fixedly connected between the upper ends of said two second links, an abutting groove being provided at the front edge on the bottom side of said seat section for receiving and connecting with said fourth link.

4. The quick disassembly structure of seat for a scooter as claimed in claim 3, wherein corresponding pin holes are respectively provided in said fourth link and said abutting groove and a pin is provided to perforating through said pin holes.

5. The quick disassembly structure of seat for a scooter as claimed in claim 4, wherein the upper ends of said first links and the rear edge at the bottom side of said seat section are perforated by a pivot rod for pivotal connection.

6. The quick disassembly structure of seat for a scooter as claimed in claim 1, wherein the engaging slots of said pivot mounts include vertical cut-out portions extending downward from the upper edges of the side walls of said accommodation grooves and horizontal cut-out portions connected laterally with said vertical cut-out portions.

7. The quick disassembly structure of seat for a scooter as claimed in claim 6, wherein said latch pieces further has hook portions formed on the bottom edges, the ends of said tenons which engage in the engaging slots of said pivot mounts being extended to the outsides of engaging slots so as to fit with said hook portions formed on the bottom edges of said latch pieces.

8. The quick disassembly structure of seat for a scooter as claimed in claim 7, wherein said latch pieces further has handles provided at the side edges thereof.

9. The quick disassembly structure of seat for a scooter as claimed in claim 1, wherein hook portions are formed on the bottom edges of said latch pieces for engaging with the ends of said tenons extending to the outsides of said engaging slots.

10. The quick disassembly structure of seat for a scooter as claimed in claim 1, wherein a pivot rod is provided to perforate between said support leg units and said seat for pivotal connection between said support leg units and said seat.
